(19) United States
(12) Patent Application Publication
(10) Pub. No.: US 2026/0014986 A1
(43) Pub. Date: Jan. 15, 2026

(54) TRAVEL CONTROL APPARATUS, DRIVING TRAINING APPARATUS, AND VEHICLE

(71) Applicant: SUBARU CORPORATION, Tokyo (JP)

(72) Inventors: Yuta TAKENOYA, Tokyo (JP); Yuichiro TSUKASAKI, Tokyo (JP); Hiroki NAGANO, Tokyo (JP); Kou SASAKI, Tokyo (JP); Yasushi TAKASO, Tokyo (JP)

(21) Appl. No.: 19/245,958

(22) Filed: Jun. 23, 2025

(30) Foreign Application Priority Data
Jul. 10, 2024 (JP) 2024-110692

(51) Int. Cl. B60W 30/16; B60W 50/14

(52) U.S. Cl. CPC B60W 30/16; B60W 50/14; B60W 2050/146; B60W 2540/215; B60W 2554/4041; B60W 2554/802; B60W 2754/30

(57) ABSTRACT

A travel control apparatus configured to be applied to a vehicle includes a processor. When: an adaptive cruise control is enabled; and first and second front vehicles are detected to be traveling in parallel ahead of the vehicle, the processor makes an inquiry of a vehicle's driver about whether to prioritize energy-saving traveling. When acquiring a response that the energy-saving traveling is not to be prioritized, the processor performs an automated travel control of the vehicle to a position facing a gap between the first and second front vehicles and achieves a set inter-vehicle distance. When acquiring a response that the energy-saving traveling is to be prioritized, the travel processor performs an automated travel control of the vehicle to the position facing the gap between the first and second front vehicles and achieves a shortest inter-vehicle distance in an allowable setting range.

### CROSS-REFERENCE TO RELATED APPLICATIONS

The present application claims priority from Japanese Patent Application No. 2024-110692 filed on Jul. 10, 2024, the entire contents of which are hereby incorporated by reference.

### BACKGROUND

The disclosure relates to a travel control apparatus, a driving training apparatus, and a vehicle.

An adaptive cruise control (ACC) is known that performs constant speed traveling while maintaining a constant distance between a vehicle and a front vehicle. The distance between the vehicle and the front vehicle is also referred to as an inter-vehicle distance. In a vehicle equipped with an ACC system, while the ACC system is operating, an accelerator pedal and a brake are automatedly operated by the ACC system even when a driver who drives the vehicle does not operate the accelerator pedal and the brake. This makes it possible to reduce a driving load of the driver, and further reduce fuel consumption or electric power consumption as compared with a case where the driver drives the vehicle manually.

A vehicle equipped with the ACC system is disclosed in, for example, Japanese Unexamined Patent Application Publication No. 2022-117882.

### SUMMARY

An aspect of the disclosure provides a travel control apparatus configured to be applied to a vehicle. The travel control apparatus includes a processor configured to acquire traffic data ahead of the vehicle and traffic participant data ahead of the vehicle, and execute an adaptive cruise control, based on the traffic data and the traffic participant data. The processor is configured to, when: the adaptive cruise control is enabled; and a first front vehicle and a second front vehicle are detected to be traveling in parallel ahead of the vehicle, based on the traffic data and the traffic participant data, make an inquiry of a driver who drives the vehicle about whether to prioritize energy-saving traveling. upon acquiring first data indicating that the energy-saving traveling is not to be prioritized as a response to the inquiry, perform an automated travel control of the vehicle and cause the vehicle to approach a position facing a gap between the first front vehicle and the second front vehicle, and perform an automated travel control and achieve an inter-vehicle distance set by the driver. The processor is configured to, upon acquiring second data indicating that the energy-saving traveling is to be prioritized as a response to the inquiry, perform an automated travel control of the vehicle and cause the vehicle to approach the position facing the gap between the first front vehicle and the second front vehicle, and perform an automated travel control and achieve a shortest inter-vehicle distance in an allowable setting range.

An aspect of the disclosure provides a driving training apparatus configured to be applied to a vehicle. The driving training apparatus a processor configured to acquire traffic data ahead of the vehicle and traffic participant data ahead of the vehicle, and execute driving training, based on the traffic data and the traffic participant data. The processor is configured to, when a first front vehicle and a second front vehicle are detected to be traveling in parallel ahead of the vehicle, based on the traffic data and the traffic participant data, make an inquiry of a driver who drives the vehicle about whether to perform the driving training. The processor is configured to, upon acquiring data indicating that the driver agrees to the driving training as a response to the inquiry, perform a presentation of a vehicle position when the energy-saving traveling is to be prioritized to the driver, make an evaluation in accordance with a degree of match between the position of the vehicle and the presented vehicle position, and present a result of the evaluation to the driver.

An aspect of the disclosure provides a vehicle. The vehicle includes a travel control apparatus including a processor. The processor is configured to acquire traffic data ahead of the vehicle and traffic participant data ahead of the vehicle, and execute an adaptive cruise control, based on the traffic data and the traffic participant data. The processor is configured to, when: the adaptive cruise control is enabled; and a first front vehicle and a second front vehicle are detected to be traveling in parallel ahead of the vehicle, based on the traffic data and the traffic participant data, make an inquiry of a driver who drives the vehicle about whether to prioritize energy-saving traveling. The processor is configured to, upon acquiring first data indicating that the energy-saving traveling is not to be prioritized as a response to the inquiry, perform an automated travel control of the vehicle and cause the vehicle to approach a position facing a gap between the first front vehicle and the second front vehicle, and perform an automated travel control and achieve an inter-vehicle distance set by the driver. The processor is configured to, upon acquiring second data indicating that the energy-saving traveling is to be prioritized as a response to the inquiry, perform an automated travel control of the vehicle and cause the vehicle to approach the position facing the gap between the first front vehicle and the second front vehicle, and perform an automated travel control and achieve a shortest inter-vehicle distance in an allowable setting range.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a diagram illustrating an example of a traffic situation in which two vehicles are traveling in parallel ahead of a vehicle.

FIG. 2 is a diagram illustrating an example of a low fluid energy region generated by the two vehicles in the traffic situation of FIG. 1.

FIG. 3 is a functional block diagram illustrating an example of a vehicle according to one example embodiment of the disclosure.

FIG. 4 is a diagram illustrating an example of an outer appearance around a driver's seat inside the vehicle of FIG. 3.

FIG. 5 is a table illustrating an example of an inter-vehicle distance table of FIG. 3.

FIG. 6 is a diagram for describing the inter-vehicle distance table of FIG. 5, based on a freeway of FIG. 2.

FIG. 7 is a diagram illustrating a modification example of a positional relationship between the two vehicles traveling in parallel in FIG. 6.

FIG. 8 is a diagram illustrating an example of how the vehicle is moved to a position where it is possible to travel while saving energy in the traffic situation of FIG. 6.

FIG. 9 is a diagram illustrating an example of how the vehicle is moved to a position where it is possible to travel while saving energy in the traffic situation of FIG. 6.

FIG. 10 is a flowchart for describing an example of a procedure of controlling traveling of the vehicle of FIG. 3.

FIG. 11 is a functional block diagram illustrating an example of a vehicle according to one example embodiment of the disclosure.

FIG. 12 is a diagram illustrating an example of an outer appearance around a driver's seat inside the vehicle of FIG. 11.

FIG. 13 is a diagram illustrating an example of a traffic situation ahead of the vehicle viewed from a front windshield of the vehicle of FIG. 12.

FIG. 14 is a flowchart for describing an example of a procedure of controlling traveling and a procedure of evaluating traveling of the vehicle of FIG. 11.

### DETAILED DESCRIPTION

An adaptive cruise control (ACC) is known that performs constant speed traveling while maintaining a constant distance between a vehicle and a front vehicle. The distance between the vehicle and the front vehicle is also referred to as an inter-vehicle distance. In a vehicle equipped with an ACC system, while the ACC system is operating, an accelerator pedal and a brake are automatedly operated by the ACC system even when a driver who drives the vehicle does not operate the accelerator pedal and the brake. This makes it possible to reduce a driving load of the driver, and further reduce fuel consumption or electric power consumption as compared with a case where the driver drives the vehicle manually.

Depending on a traffic situation ahead of the vehicle, it is sometimes possible to perform travel control that makes it possible to further reduce the fuel consumption or the electric power consumption as compared with a case where the ACC is simply used. What is desired is to provide a travel control apparatus and a vehicle that each make it possible to reduce fuel consumption or electric power consumption. Furthermore, what is desired is to provide a travel control apparatus and a vehicle that each make it possible to reduce fuel consumption or electric power consumption as compared with a case where the ACC is simply used. When the driver manually operates a steering wheel, the accelerator pedal, and the brake of the vehicle, which are to be automatedly operated by the above-described travel control, the driver it to operate the vehicle using spatial awareness. An operation of the vehicle by the driver using spatial awareness can serve as a dementia prevention training for the driver. What is desired is to provide a dementia prevention training apparatus and a vehicle that each make it possible to prevent dementia of the driver. Furthermore, what is desired is to provide a dementia prevention training apparatus and a vehicle that each make it possible to prevent dementia of the driver while reducing fuel consumption or electric power consumption.

It is desirable to provide a travel control apparatus, a driving training apparatus, a dementia prevention training apparatus, and a vehicle that each make it possible to reduce fuel consumption or electric power consumption.

In the following, example embodiments of the disclosure will be described in detail with reference to the drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

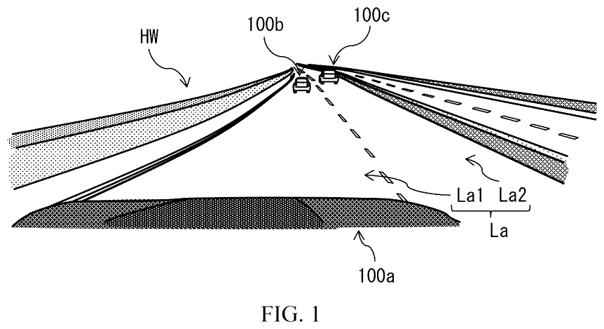

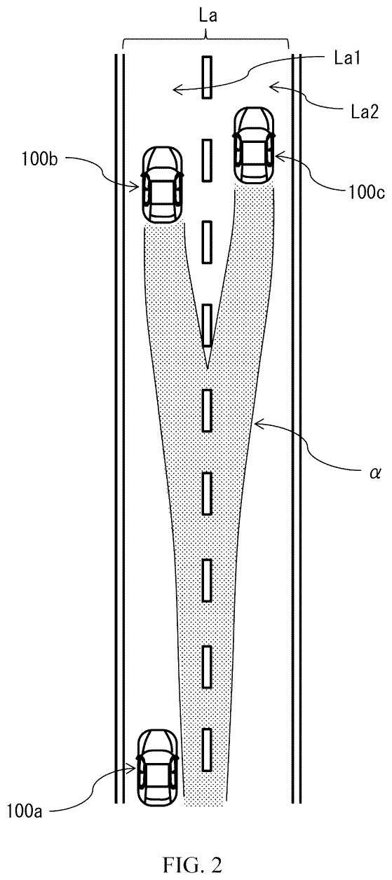

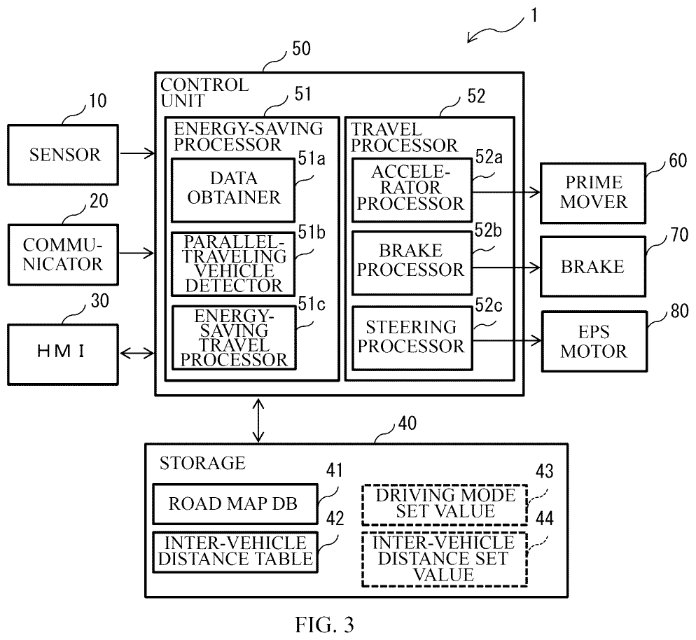

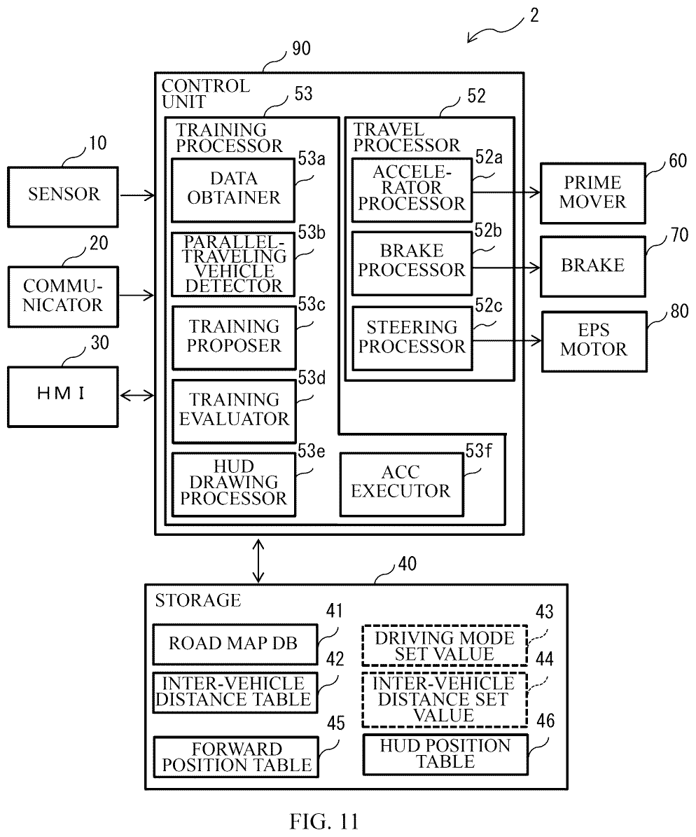

The description of the disclosure will be given in the following order.
1. Principle of Energy-Saving Traveling (FIGS. 1 and 2)
2. First Example Embodiment (FIGS. 3 to 10)
   Example of Performing Energy-Saving Traveling When ACC Is ON
3. Second Example Embodiment (FIGS. 11 to 14)
   Example of Performing Dementia Prevention Training When ACC Is ON
4. Modification Examples of Second Example Embodiment
   Example of Performing Dementia Prevention Training When ACC Is OFF

### 1. Principle of Energy-Saving Traveling

FIG. 1 is a diagram illustrating an example of a traffic situation in which two vehicles 100b and 100c are traveling in parallel ahead of a vehicle 100a. FIG. 2 is a diagram illustrating an example of a low fluid energy region a generated by the two vehicles 100b and 100c in the traffic situation of FIG. 1.

In general, when a vehicle is traveling on a general road or a freeway, an airflow may be generated around the traveling vehicle in accordance with a shape, a size, a speed, and other factors related to the vehicle. The airflow may cause air resistance to the traveling vehicle, which may be one of the factors that deteriorate fuel consumption or electric power consumption of the vehicle. In contrast, when another vehicle is traveling ahead of the vehicle, the airflow generated by the front vehicle may affect the airflow generated around the vehicle. The vehicle traveling ahead of the vehicle may hereafter be referred to as a “front vehicle”. Behind the front vehicle that is traveling, a region may be generated in which fluid energy is low due to the airflow generated by the front vehicle. Such region may hereafter be referred to as a “low fluid energy region”. When the vehicle travels in the low fluid energy region, the air resistance on the vehicle may be smaller than that when the vehicle travels outside the low fluid energy region. Accordingly, it is possible to improve the fuel consumption or the electric power consumption of the vehicle by allowing the vehicle to travel in the low fluid energy region.

For example, as illustrated in FIG. 1, it may be assumed that, on a freeway HW with two lanes on each side, the vehicle 100a travels in a lane La1 on a left side of a lane La. In this situation, for example, as illustrated in FIGS. 1 and 2, it may be assumed that, in a region ahead of the vehicle 100a, the vehicle 100b is traveling in the lane La1, the vehicle 100c is traveling in a lane La2 on a right side of the lane La. Furthermore, it may be assumed that the two vehicles 100b and 100c are traveling in parallel. At this time, the two vehicles 100b and 100c that travel in parallel may generate a low fluid energy region a. In the low fluid energy region a, a low fluid energy region generated by the vehicle 100b and a low fluid energy region generated by the vehicle 100c may be separate from each other in the vicinity of the two vehicles 100b and 100c, and may be integrated at a position apart from the two vehicles 100b and 100c by a predetermined distance or more.

Here, in the low fluid energy region a, a region where the low fluid energy region generated by the vehicle 100b and the low fluid energy region generated by the vehicle 100c are integrated may be referred to as a specific region X. Further, when the vehicles 100b and 100c are traveling apart from each other to such an extent that the low fluid energy regions generated by the vehicles 100b and 100c are not integrated, the low fluid energy region generated by each of the vehicles 100b and 100c may be referred to as a specific region Y. When fluid energy of the specific region X and fluid energy of the specific region Y are compared with each other using distances from the vehicles 100b and 100c as parameters, the fluid energy of the specific region X may be lower than the fluid energy of the specific region Y. Allowing the vehicle 100a to travel in the specific region X generated by the two vehicles 100b and 100c therefore makes it possible to further improve the fuel consumption or the electric power consumption of the vehicle 100a as compared with a case of allowing the vehicle 100a to travel in the specific region Y generated by the vehicle 100b or the vehicle 100c. In one embodiment, the vehicle 100b may serve as a “first front vehicle”. In one embodiment, the vehicle 100c may serve as a “second front vehicle”.

As a result of intensive study, the applicant of the disclosure developed a method that further improves the fuel consumption or the electric power consumption of the vehicle 100a. For example, as illustrated in FIGS. 1 and 2, when the two vehicles 100b and 100c traveling in parallel are present ahead of the vehicle 100a, the vehicle 100a may be caused to perform travel control that allows the vehicle 100a to so move that at least part of the vehicle 100a enters the specific region X. Hereinafter, description is given of a control unit 50 that implements this method and a vehicle 1 including the control unit 50.

When a driver who drives the vehicle 100a manually operates a steering wheel, an accelerator pedal, and a brake of the vehicle 100a, which are to be automatedly operated by the above-described travel control, the driver may be to operate the vehicle 100a using spatial awareness. An operation of the vehicle by the driver using spatial awareness can serve as a dementia prevention training for the driver. As a result of intensive study, the applicant of the disclosure developed a method that prevents dementia of the driver. The method may include, when the two vehicles 100b and 100c traveling in parallel are present ahead of the vehicle 100a, causing the driver to execute an operation to so move the vehicle 100a that at least part of the vehicle 100a enters the specific region X. Hereinafter, description is given of a control unit 90 that implements such a method and a vehicle 2 including the control unit 90.

### 2. First Example Embodiment

### Configuration Example

FIG. 3 illustrates an example of functional blocks of the vehicle 1 according to a first example embodiment of the disclosure. The vehicle 1 may correspond to an example of the vehicle 100a. As illustrated in FIG. 3, the vehicle 1 may include, for example but not limited to, a sensor 10, a communicator 20, a human-machine interface (HMI) 30, a storage 40, a control unit 50, a prime mover 60, a brake 70, and an electric power steering (EPS) motor 80.

The sensor 10 may include various kinds of sensors mounted on the vehicle 1. The sensor 10 may include, for example but not limited to, a vehicle speed sensor, an acceleration sensor, an angular velocity sensor, a steering angular velocity sensor, and a steering torque sensor. In some embodiments, the sensor 10 may include any sensor other than those described above.

The vehicle speed sensor may be configured to detect the speed of the vehicle 1, which may also be referred to as a vehicle speed. The vehicle speed sensor may be configured to output time-series data regarding the detected vehicle speed to the control unit 50. The time-series data regarding the detected vehicle speed may be referred to as vehicle speed data. The acceleration sensor may be configured to detect an acceleration rate applied to the vehicle 1. The acceleration sensor may be configured to output time-series data regarding the detected acceleration rates in three directions to the control unit 50. The time-series data regarding the detected acceleration rates in three directions may be referred to as acceleration rate data. The angular velocity sensor may be configured to detect an angular velocity of the vehicle 1. The angular velocity sensor may be configured to output time-series data regarding three detected angular velocities including yaw rate, roll velocity, and pitch velocity to the control unit 50. The time-series data regarding three detected angular velocities may be referred to as angular velocity data.

The steering angular velocity sensor may be configured to detect a rotational velocity of a steering angle of a steering wheel of the vehicle 1. The steering angular velocity sensor may be configured to output time-series data regarding the detected steering angular velocity to the control unit 50. The steering torque sensor may be configured to detect a steering torque generated by a steering operation of the driver. The steering torque sensor may be configured to output time-series data regarding the detected steering torque to the control unit 50. The time-series data regarding the detected steering torque may be referred to as a steering torque TR.

The sensor 10 may further include a stereo camera mounted on the vehicle 1 and a travel environment detector. The stereo camera may include an automated sensor that detects a real space around the vehicle 1. For example, the stereo camera may include cameras disposed at symmetrical positions with respect to a middle part of the vehicle 1 in a width direction of the vehicle 1, and may be configured to perform stereo imaging of a region ahead of the vehicle 1 from different viewpoints. The stereo camera may be configured to output image data Da obtained by imaging to the control unit 50. The image data Da may include a pair of stereo image data pieces.

The stereo camera may be configured to generate range image data Db obtained from a difference between positions of a corresponding target, based on the image data Da, or the pair of stereo image data pieces, obtained by imaging. The travel environment detector may be configured to, for example, obtain a lane line that defines a road around the vehicle 1, based on the range image data Db. The travel environment detector may further be configured to obtain a road curvature of the lane lines that define the left and the right of a traveling road, or a traveling lane, on which the vehicle 1 travels, and a width, or a lane width, between the left and right lane lines. The travel environment detector may further be configured to perform, for example, predetermined pattern matching on the range image data Db and detect a lane or a three-dimensional object such as a structure present around the vehicle 1.

Here, in the detection of the three-dimensional object, the travel environment detector may detect, for example but not limited to, a kind of the three-dimensional object, a distance to the three-dimensional object, a speed of the three-dimensional object, and a relative speed between the three-dimensional object and the vehicle. Non-limiting examples of the three-dimensional object to be detected may include traffic lights, intersections, road signs, stop lines, other vehicles, pedestrians, bicycles, and architecture. Non-limiting examples of the architecture may include houses, apartments (condominiums), commercial facilities, factories, and signboards. The travel environment detector may be configured to output, to the control unit 50, travel environment information around the vehicle 1 including, for example but not limited to, information on the three-dimensional object acquired in this manner.

The communicator 20 may be configured to acquire, through, for example but not limited to, vehicle-to-vehicle communication, road-to-vehicle communication, and satellite communication, data that supplement data that is difficult to be obtained from the image data Da and the range image data Db. The communicator 20 may be configured to output the acquired data to the control unit 50.

The communicator 20 may be configured to, for example, acquire data, such as a vehicle position and a vehicle speed, obtained by another vehicle through vehicle-to-vehicle communication. The communicator 20 may be configured to, for example, receive positioning signals transmitted from a plurality of positioning satellites, through satellite communication.

The communicator 20 may be configured to, for example, acquire road map data of the region around the vehicle 1 through road-to-vehicle communication. The road map data may include, for example, high-precision road map information. The high-precision road map information may include a dynamic map. The road map data may include static information and quasi-static information that mainly constitute road information, and quasi-dynamic information and dynamic information that mainly constitute traffic information.

The static information constituting the road information may include, for example, information that is to be updated by frequency within one month. Such information may include, for example but not limited to, information on roads, information on structures on a road, information on structures around a road, lane information, road surface information, and permanent restriction information. Non-limiting examples of the information on roads may include position information and shape information of roads, and attribute information of intersections and roads (e.g., national road, prefectural road, city road, private road, priority road, non-priority road, general road, freeway, a number of lanes, presence or absence of a median, presence or absence of a right-turn-only lane, time separated type, pedestrian-vehicle separated type). Non-limiting examples of the information on structures on a road may include traffic signs, traffic lights, curved mirrors, pedestrian bridges, stops, and garbage collection stations. Non-limiting examples of the information on structures around a road may include various kinds of buildings and parks.

The quasi-static information constituting the road information may include information that is to be updated by frequency within one hour. Such information may include, for example but not limited to, traffic restriction information due to a circumstance such as road construction or an event, wide-area weather information, and traffic congestion prediction.

The quasi-dynamic information constituting the traffic information may include information that is to be updated by frequency within one minute. Such information may include, for example but not limited to, an actual traffic congestion situation or a travel restriction at a time of observation, a temporary travel obstruction situation, such as a fallen object or an obstacle, a state of an actual unexpected event, and narrow-area weather information.

The dynamic information constituting the traffic information may include information that is to be updated by frequency in units of one second. Such information may include, for example but not limited to, information transmitted and exchanged between mobile objects, information on current indication on a traffic light, information on pedestrians and bicycles in an intersection, and information on vehicles traveling on a road. Such road map information may be maintained and updated in a cycle until next information is received from each of the vehicles, and the updated road map information may be appropriately transmitted to each of the vehicles through the communicator 20.

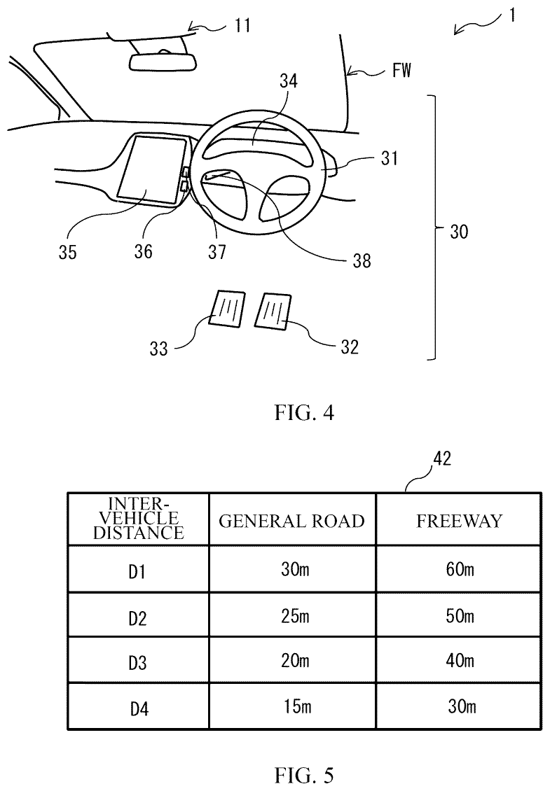

As illustrated in FIG. 4, the HMI 30 may include, for example but not limited to, a steering wheel 31, an accelerator pedal 32, a brake pedal 33, a meter panel display 34, a center panel display 35, a speaker 36, a microphone 37, and a paddle shift 38. The meter panel display 34 may include a display panel such as a liquid crystal display panel or an organic EL display panel, and may be configured to, for example, display information including, without limitation, a vehicle speed and an engine speed. The center panel display 35 may include a display panel such as a touch-input liquid crystal display panel or a touch-input organic EL display panel, and may be configured to allow various kinds of settings of the vehicle 1 to be performed, for example.

The paddle shift 38 may be configured to receive an input of a driving mode set value 43 from the driver. The paddle shift 38 may be, for example, a shift lever added to the steering wheel 31. The paddle shift 38 may be configured to store “1” in the storage 40 as the driving mode set value 43 when, for example, the paddle shift 38 is long-pressed by the driver. The paddle shift 38 may be configured to store “0” in the storage 40 as the driving mode set value 43 when, for example, the paddle shift 38 is long-pressed by the driver again after storing “1” in the storage 40 as the driving mode set value 43 last time.

The paddle shift 38 may be configured to store “2” in the storage 40 as the driving mode set value 43 when, for example, the paddle shift 38 is short-pressed once by the driver. The paddle shift 38 may be configured to store “0” in the storage 40 as the driving mode set value 43 when, for example, the paddle shift 38 is short-pressed once by the driver again after storing “2” in the storage 40 as the driving mode set value 43 last time.

When the driving mode set value 43 is “0”, the driving mode set value 43 may mean, for example, that a manual driving mode is on. When the driving mode set value 43 is “1”, the driving mode set value 43 may mean, for example, that a travel control mode is on. When the driving mode set value 43 is “2”, the driving mode set value 43 may mean, for example, that an ACC mode is on. The driving mode set value 43 can take any value such as “3” or “4” as will be described later. When the driving mode set value 43 is “3”, the driving mode set value 43 may mean, for example, that a safe traveling mode is on. When the driving mode set value 43 is “4”, the driving mode set value 43 may mean, for example, that an energy-saving mode is on. Note that the value that can be set as the driving mode set value 43 may not be limited to the above values. The method of setting the driving mode set value 43 may not be limited to the use of the paddle shift 38. Various kinds of modes described above will be described in detail later.

The storage 40 may include, for example, a nonvolatile memory. Non-limiting examples of the nonvolatile memory may include an Electrically Erasable Programmable Read-Only Memory (EEPROM), a flash memory, and a resistance random access memory. As illustrated in FIG. 3, the storage 40 may hold, for example, a road map database (DB) 41 and an inter-vehicle distance table 42.

The road map DB 41 may include high-precision road map information. The high-precision road map information may include a dynamic map. The high-precision road map information may include, for example, static information and quasi-static information mainly constituting the road information, and quasi-dynamic information and dynamic information mainly constituting the traffic information, similarly to the road map information acquired from the outside of the vehicle 1 through road-to-vehicle communication.

The inter-vehicle distance table 42 may include, for example, a table in which a plurality of inter-vehicle distances D1 to D4 are specified for each type of road as illustrated in FIG. 5. The inter-vehicle distance table 42 may specify, for example, a general road and a freeway as road types. The inter-vehicle distance table 42 may specify 30 m, 25 m, 20 m, and 15 m as the inter-vehicle distances D1 to D4 for the general road, and 60 m, 50 m, 40 m, and 30 m as the inter-vehicle distances D1 to D4 for the freeway. The values of the inter-vehicle distances D1 to D4 specified in the inter-vehicle distance table 42 may not be limited to those in FIG. 5. A number of the inter-vehicle distances D1 to D4 specified in the inter-vehicle distance table 42 may not be limited to four.

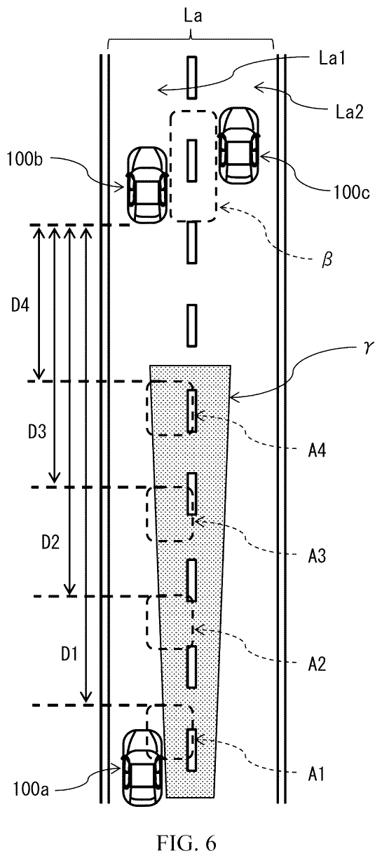

The inter-vehicle distance D1 may indicate, for example, a distance between the vehicle 100a and the vehicle 100b when the vehicle 100a is traveling at a first position A1 in the traffic situation as illustrated in FIG. 6. The inter-vehicle distance D2 may indicate, for example, a distance between the vehicle 100a and the vehicle 100b when the vehicle 100a is traveling at a second position A2 in the traffic situation of the freeway HW as illustrated in FIG. 6. The inter-vehicle distance D3 may indicate, for example, a distance between the vehicle 100a and the vehicle 100b when the vehicle 100a is traveling at a third position A3 in the traffic situation of the freeway HW as illustrated in FIG. 6. The inter-vehicle distance D4 may indicate, for example, a distance between the vehicle 100a and the vehicle 100b when the vehicle 100a is traveling at a fourth position A4 in the traffic situation of the freeway HW as illustrated in FIG. 6.

In FIG. 6, an energy-saving region γ may include a region corresponding to the above-described specific region X, and may be located at a position facing a gap β between the two vehicles 100b and 100c traveling in parallel, in an extending direction of the lane La. The energy-saving region γ may have a band shape extending in the extending direction of the lane La. The energy-saving region γ may include, for example, a trapezoidal shape. The shape of the energy-saving region γ may not be limited to the trapezoidal shape. An end part of the energy-saving region γ corresponding to the vehicle 100a may be located at the first position A1, and an end part of the energy-saving region γ corresponding to the vehicle 100b may be located at the fourth position A4.

In FIG. 6, the first position A1, the second position A2, the third position A3, and the fourth position A4 may have, for example, substantially the same size as that of the vehicle 100a in plan view. In FIG. 6, the first position A1, the second position A2, the third position A3, and the fourth position A4 may be located within the lane La1 in which the vehicle 100a travels and may be located at positions including part of the energy-saving region γ. Accordingly, at least part of the vehicle 100a may be located within the energy-saving region γ when the vehicle 100a is traveling at the first position A1, the second position A2, the third position A3, or the fourth position A4.

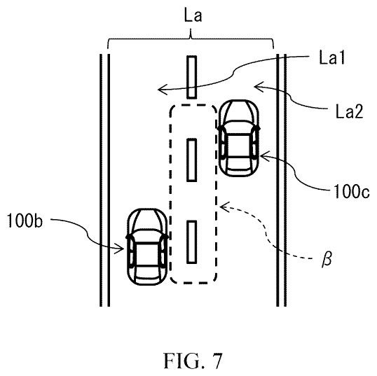

Here, “traveling in parallel” may refer to, for example, a case in which at least part of the vehicle 100b and part of the vehicle 100c are opposed to each other with the gap β interposed therebetween in a width direction of the lane La as illustrated in FIG. 6. However, herein, the two vehicles 100b and 100c may be interpreted as “traveling in parallel” when the two vehicles 100b and 100c traveling in different lanes La1 and La2 from each other satisfy a condition that the low fluid energy region generated by the vehicle 100b and the low fluid energy region generated by the vehicle 100c are disposed at positions overlapping each other for at least several tens of meters. Accordingly, even when the vehicles 100b and 100c are opposed to each other with the gap β interposed therebetween in a direction oblique to the width direction of the lane La as illustrated in FIG. 7 for example, the two vehicles 100b and 100c may also be interpreted as “traveling in parallel” as long as the above condition is satisfied.

The storage 40 may hold the driving mode set value 43 and an inter-vehicle distance set value 44. The driving mode set value 43 may include data indicating one driving mode selected out of a plurality of driving modes that can be adopted for the vehicle 1. The driving mode set value 43 may include a value such as 0, 1, 2, 3, or 4 as data indicating the driving mode. The driving mode set value 43 may be set by a device such as the paddle shift 38. In some embodiments, the driving mode set value 43 may be, for example, set by any device other than the paddle shift 38. The inter-vehicle distance set value 44 may include data indicating the inter-vehicle distance inputted by the driver. The inter-vehicle distance inputted by the driver may be referred to as a set inter-vehicle distance. The inter-vehicle distance set value 44 may be set to, for example, D1, D2, D3 or D4 as the data indicating the set inter-vehicle distance. The inter-vehicle distance set value 44 may be set by, for example, a touch operation on the center panel display 35 by the driver. In some embodiments, the inter-vehicle distance set value 44 may be set by, for example, any method other than the touch operation on the center panel display 35 by the driver.

The inter-vehicle distance set value 44 may include an inter-vehicle distance set value for a general road and an inter-vehicle distance set value for a freeway. When the inter-vehicle distance set value for the general road is “1”, it may mean that, for example, D1 (e.g., 30 m) is set as the inter-vehicle distance for the general road. When the inter-vehicle distance set value for the general road is “2”, it may mean that, for example, D2 (e.g., 25 m) is set as the inter-vehicle distance for the general road. When the inter-vehicle distance set value for the general road is “3”, it may mean that, for example, D3 (e.g., 20 m) is set as the inter-vehicle distance for the general road. When the inter-vehicle distance set value for the general road is “4”, it may mean that, for example, D4 (e.g., 15 m) is set as the inter-vehicle distance for the general road.

When the inter-vehicle distance set value for the freeway is “1”, it may mean that, for example, D1 (e.g., 60 m) is set as the inter-vehicle distance for the freeway. When the inter-vehicle distance set value for the freeway is “2”, it may mean that, for example, D2 (e.g., 50 m) is set as the inter-vehicle distance for the freeway. When the inter-vehicle distance set value for the freeway is “3”, it may mean that, for example, D3 (e.g., 40 m) is set as the inter-vehicle distance for the freeway. When the inter-vehicle distance set value for the freeway is “4”, it may mean that, for example, D4 (e.g., 30 m) is set as the inter-vehicle distance for the freeway. Note that the value that can be adopted as the inter-vehicle distance set value 44 may not be limited to those described above.

The control unit 50 may be configured to control an overall operation of the vehicle 1. The control unit 50 may include, for example but not limited to, what is called an electronic control unit (ECU), and include, for example, one or more processors and one or more memories. In some embodiments, the control unit 50 may include, for example but not limited to, a central processing unit (CPU). In this case, the control unit 50 may be configured to control the overall operation of the vehicle 1 by, for example, executing a program stored in a storage.

The control unit 50 may include, for example, a locator. The locator may be configured to acquire position coordinates of the vehicle 1, based on the positioning signals received through the communicator 20. The locator may be configured to estimate the position of the vehicle on a road map by map matching the acquired position coordinates on route map information. Based on the acquired position coordinates of the vehicle 1, the locator may acquire map information of a predetermined range including the vehicle 1 from map information stored in the road map DB 41.

The locator may be configured to, in an environment in which it is difficult to receive effective positioning signals from the positioning satellites due to a decrease in sensitivity, such as a case of traveling in a tunnel, estimate the position of the vehicle on the road map by switching to automated navigation where the position of the vehicle is estimated based on the vehicle speed, the angular velocity, and a longitudinal acceleration rate detected by the sensor 10.

The locator may be configured to, when estimating the position of the vehicle 1, i.e., the vehicle position, on the road map, based on, for example but not limited to, the positioning signals received through the communicator 20 or the information detected by the sensor 10 as described above, determine the road type and other characteristics of the traveling road on which the vehicle 1 is traveling, based on the estimated vehicle position on the road map.

The locator may be configured to update the road map information stored in the road map DB 41 to the most recent state, based on the road map information acquired by external communication through the communicator 20. The external communication may include, for example but not limited to, road-to-vehicle communication and vehicle-to-vehicle communication. The update of the information may be performed not only for static information but also for quasi-static information, quasi-dynamic information, and dynamic information. Accordingly, the road map information may include the road information and the traffic information acquired through communication with the outside of the vehicle. In the road map information, the information on a mobile object such as a vehicle traveling on a road may be updated substantially in real time.

The locator may verify the road map information, based on the travel environment information recognized as described above, and update the road map information stored in the road map DB 41 to the most recent state. The update of the information may be performed not only for static information but also for quasi-static information, quasi-dynamic information, and dynamic information. Accordingly, the information on the mobile object such as the vehicle traveling on the road recognized as described above may be updated in real time.

The control unit 50 may further include, for example, a travel processor 52 as illustrated in FIG. 3. In one embodiment, the travel processor 52 may serve as a “travel processor”. The travel processor 52 may control the vehicle 1 in accordance with the driving mode. Non-limiting examples of the driving mode may include a manual driving mode and a travel control mode. The manual driving mode may include a driving mode in which a driver is to hold the steering, and include, for example, a driving mode in which the vehicle 1 is caused to travel in accordance with a driving operation such as a steering operation, an accelerator pedal operation, and a brake operation performed by the driver.

The travel control mode may include a driving mode in which the driver is supported to enhance safety of, for example but not limited to, a pedestrian or a vehicle around the vehicle 1 when the driver performs a driving operation. The travel processor 52 may be configured to, in the travel control mode, perform a travel control adapted to support the driver, based on, for example, data acquired by a data obtainer 51a to be described later. Non-limiting examples of the travel control may include an accelerator control, a brake control, and a steering control. The travel control mode may include the ACC mode, the safe traveling mode, and the energy-saving mode.

The ACC mode may include a driving mode in which constant speed traveling is performed while maintaining a constant distance, i.e., a constant inter-vehicle distance, between the vehicle 1 and the vehicle traveling ahead of the vehicle 1, i.e., the front vehicle, in the lane La1 in which the vehicle 1 travels. The travel processor 52 may be configured to, in the ACC mode, for example, perform a travel control including, for example but not limited to, an accelerator control, a brake control, and a steering control adapted to perform constant speed traveling while maintaining a constant inter-vehicle distance between the vehicle and the front vehicle, based on data acquired by the data obtainer 51a.

The safe traveling mode may include a driving mode in which the driver is supported to improve the fuel consumption or the electric power consumption of the vehicle 1 with priority given to traveling safety of the vehicle 1. The travel processor 52 may be configured to, in the safe traveling mode, perform a travel control including, for example but not limited to, an accelerator control, a brake control, and a steering control adapted to move the vehicle 1 from a current position of the vehicle 1 to a target position that is set in accordance with the set inter-vehicle distance to be described later, based on, for example, the data acquired by the data obtainer 51a and data acquired by an energy-saving travel processor 51c to be described later.

The energy-saving mode may include a driving mode in which the driver is supported to prioritize improvement of the fuel consumption or the electric power consumption of the vehicle 1. The travel processor 52 may be configured to, in the energy-saving mode, perform a travel control including, for example but not limited to, an accelerator control, a brake control, and a steering control adapted to move the vehicle 1 from the current position of the vehicle 1 to a target position that is set in accordance with a shortest inter-vehicle distance to be described later, based on, for example, the data acquired by the data obtainer 51a and the data acquired by the energy-saving travel processor 51c to be described later.

The travel processor 52 may be configured to read the driving mode set value 43 from the storage 40 and set the driving mode, based on the read driving mode set value 43. The travel processor 52 may be configured to, when the driving mode set value 43 is “0”, set the driving mode to the manual driving mode. The travel processor 52 may be configured to, when the driving mode is in the manual driving mode, set a correction torque to be described later to zero, and control the prime mover 60, the brake 70, and the EPS motor 80 in accordance with the accelerator pedal operation, the brake operation, and the steering wheel operation performed by the driver who drives the vehicle 1.

The travel processor 52 may be configured to, when the driving mode set value 43 is “1”, set the driving mode to the travel control mode. The travel processor 52 may be configured to, when the driving mode is in the travel control mode, generate a correction torque to be used to support the driver, based on the data acquired by the data obtainer 51a, and control the prime mover 60, the brake 70, and the EPS motor 80, based on the generated correction torque.

The travel processor 52 may be configured to, when the driving mode set value 43 is “2”, set the driving mode to the ACC mode. The travel processor 52 may be configured to, when the driving mode is in the ACC mode, generate the correction torque to be used to perform the constant speed traveling while maintaining the constant inter-vehicle distance between the vehicle and the front vehicle, based on the data acquired by the data obtainer 51a, and control the prime mover 60, the brake 70, and the EPS motor 80, based on the generated correction torque.

The travel processor 52 may be configured to, when the driving mode set value 43 is “3”, set the driving mode to the safe traveling mode. The travel processor 52 may be configured to, when the driving mode is in the safe traveling mode, generate, based on the data acquired by the data obtainer 51a and the data, or a control signal, acquired by the energy-saving travel processor 51c to be described later, the correction torque to be used to move the vehicle 1 from the current position of the vehicle 1 to the target position set based on the set inter-vehicle distance to be described later, and control the prime mover 60, the brake 70, and the EPS motor 80, based on the generated correcting torque.

The travel processor 52 may be configured to, when the driving mode set value 43 is “4”, set the driving mode to the energy-saving mode. The travel processor 52 may be configured to, when the driving mode is in the energy-saving mode, generate, based on the data acquired by the data obtainer 51a and the data, or a control signal, acquired by the energy-saving travel processor 51c to be described later, the correction torque to be used to move the vehicle 1 from the current position of the vehicle 1 to the target position set based on the shortest inter-vehicle distance to be described later, and control the prime mover 60, the brake 70, and the EPS motor 80, based on the generated correction torque.

As illustrated in FIG. 3, the travel processor 52 may include, for example but not limited to, an accelerator processor 52a, a brake processor 52b, and a steering processor 52c.

The accelerator processor 52a may be configured to control the torque of the prime mover 60, based on a requested torque corresponding to an amount of depression of the accelerator pedal by the driver who drives the vehicle 1. The accelerator processor 52a may further be configured to control the torque of the prime mover 60, based on a target torque to be obtained by adding the above-described correction torque to the requested torque. The prime mover 60 may be configured to drive steered wheels of the vehicle 1, and may be configured to drive steered wheels of the vehicle 1 in accordance with the requested torque or the target torque received from the accelerator processor 52a.

The brake processor 52b may be configured to control a torque (a braking force) of the brake 70, based on a requested torque corresponding to an amount of depression of the brake pedal by the driver who drives the vehicle 1. The brake processor 52b may further be configured to control the torque (the braking force) of the brake 70, based on a target torque to be obtained by adding the above-described correction torque to the requested torque. The brake 70 may be configured to brake the steered wheels of the vehicle 1, and may be configured to brake the steered wheels of the vehicle 1 in accordance with the requested torque or the target torque received from the brake processor 52b.

The steering processor 52c may be configured to derive a steering assist torque that assists the steering torque generated by the steering operation of the driver, and set an EPS torque corresponding to the derived steering assist torque. The steering processor 52c may be configured to output a control signal to the EPS motor 80 to allow an output torque of the EPS motor 80 achieve the EPS torque that has been set. The steering processor 52c may be configured to output a control signal to the EPS motor 80 to allow the output torque of the EPS motor 80 achieve the EPS torque with the above-described correction torque being added. The EPS motor 80 may be configured to generate the output torque, based on the received control signal and control the steering angle of the steering wheel.

The control unit 50 may further include an energy-saving processor 51 as illustrated in FIG. 3, for example. As illustrated in FIG. 3, the energy-saving processor 51 may include, for example but not limited to, the data obtainer 51a, a parallel-traveling vehicle detector 51b, and the energy-saving travel processor 51c. In one embodiment, the data obtainer 51a may serve as an “obtainer”. In one embodiment, the data obtainer 51a may serve as “circuitry”. In one embodiment, the parallel-traveling vehicle detector 51b and the energy-saving travel processor 51c may serve as a “travel processor”. In one embodiment, the parallel-traveling vehicle detector 51b and the energy-saving travel processor 51c may serve as “circuitry”. In one embodiment, the control unit 50 may serve as a “travel control apparatus”.

The data obtainer 51a may be configured to periodically acquire data regarding a situation or a condition of the vehicle 1. For example, the data obtainer 51a may be configured to periodically acquire, by monitoring, various kinds of data obtained from the sensor 10, various kinds of data obtained from the outside of the vehicle 1 via the communicator 20, and various kinds of control signals for various kinds of devices of the vehicle 1. The data obtainer 51a may further be configured to acquire map data around the vehicle 1 from the road map DB 41 in the storage 40.

The data obtainer 51a may be configured to acquire traffic data ahead of the vehicle 1 that is traveling, based on the acquired data including, for example but not limited to, various kinds of data obtained from the sensor 10, various kinds of data obtained from the outside of the vehicle 1 via the communicator 20, various kinds of data obtained from the HMI 30, various kinds of control signals for various kinds of devices of the vehicle 1, and map data obtained from the road map DB 41. The data obtainer 51a may be configured to acquire data of the vehicle 1 and traffic participant data ahead of the vehicle 1, based on the acquired data including, for example but not limited to, various kinds of data obtained from the sensor 10, various kinds of data obtained from the outside of the vehicle 1 via the communicator 20, various kinds of data obtained from the HMI 30, various kinds of control signals for various kinds of devices of the vehicle 1, and map data obtained from the road map DB 41.

The traffic data ahead of the vehicle 1 included in the data obtained by the data obtainer 51a may include, for example, the above-described road information. In one embodiment, the road information may serve as “traffic data ahead of the vehicle”. The traffic participant data ahead of the vehicle 1 included in the data obtained by the data obtainer 51a may include, for example, the above-described traffic information. In one embodiment, the traffic information may serve as “traffic participant data ahead of the vehicle”.

The parallel-traveling vehicle detector 51b may be configured to detect whether two vehicles traveling ahead of the vehicle 1 are traveling in parallel, based on the data obtained by the data obtainer 51a. The parallel-traveling vehicle detector 51b may be configured to, for example, when the traffic situation ahead of the vehicle 1 (the vehicle 100a) is in the traffic situation as illustrated in FIG. 1, detect whether the vehicles 100b and 100c are traveling in parallel ahead of the vehicle 1 (the vehicle 100a), based on the data obtained by the data obtainer 51a.

The parallel-traveling vehicle detector 51b may be configured to, when detecting that two vehicles traveling ahead of the vehicle 1 are traveling in parallel, make an inquiry of the driver about whether to prioritize the energy-saving traveling. The parallel-traveling vehicle detector 51b may be configured to, for example, generate an audio signal for the inquiry and output the audio signal to the HMI 30 (the speaker 36). The speaker 36 may be configured to, when the audio signal for the inquiry is received, output audio in accordance with the received audio signal. The speaker 36 may be configured to, for example, output an audio message inquiring whether to prioritize the energy-saving traveling.

The parallel-traveling vehicle detector 51b may be configured to acquire a response from the driver to the inquiry. For example, the microphone 37 may be configured to, after the above-described audio message is outputted from the speaker 36, collect a response in audio from the driver to the above-described audio message. The microphone 37 may be configured to convert the audio from the driver obtained by audio collection into an audio signal and output the audio signal to the control unit 50, or to the parallel-traveling vehicle detector 51b. The parallel-traveling vehicle detector 51b may be configured to acquire a response from the driver to the inquiry by analyzing the audio signal received from the microphone 37.

The parallel-traveling vehicle detector 51b may be configured to analyze whether the response from the driver to the inquiry corresponds to data indicating that the energy-saving traveling is not to be prioritized or data indicating that the energy-saving traveling is to be prioritized. The data indicating that the energy-saving traveling is not to be prioritized may be referred to as first data. The data indicating that the energy-saving traveling is to be prioritized may be referred to as second data. The parallel-traveling vehicle detector 51b may be configured to, when, as a result of the analysis, the response from the driver to the inquiry corresponds to the data indicating that the energy-saving traveling is not to be prioritized, or the safe traveling is to be prioritized, output a control flag indicating that the energy-saving traveling is not to be prioritized to the energy-saving travel processor 51c. The parallel-traveling vehicle detector 51b may be configured to, when, as a result of the analysis, the response from the driver to the inquiry corresponds to the data indicating that the energy-saving traveling is to be prioritized, output a control flag indicating that the energy-saving traveling is to be prioritized to the energy-saving travel processor 51c.

The energy-saving travel processor 51c may be configured to, when acquiring the control flag indicating that the energy-saving traveling is not to be prioritized, store “3” in the storage 40 as the driving mode set value 43. The energy-saving travel processor 51c may be configured to, when acquiring the control flag indicating that the energy-saving traveling is not to be prioritized, perform an automated travel control of the vehicle 1 to cause the vehicle 1 to approach a position facing a gap between two vehicles traveling in parallel, in an extending direction of a lane in which two vehicles travel in parallel, and also perform an automated travel control of the vehicle 1 to achieve the inter-vehicle distance set by the driver, i.e., the set inter-vehicle distance. The energy-saving travel processor 51c may be configured to generate a control signal to be used to implement such an automated travel control, based on the data acquired by the data obtainer 51a, and output the control signal to the travel processor 52.

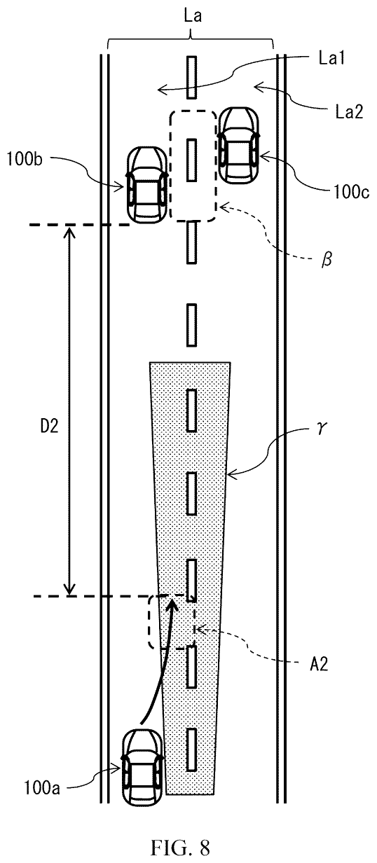

The energy-saving travel processor 51c may be configured to acquire the type of the lane in which the vehicle 1 (the vehicle 100a) is traveling, based on the data acquired by the data obtainer 51a. The energy-saving travel processor 51c may be configured to read the inter-vehicle distance set value 44 from the storage 40, and to read, from the inter-vehicle distance table 42 in the storage 40, the inter-vehicle distance, i.e., the set inter-vehicle distance corresponding to the type of the lane and the inter-vehicle distance set value 44. For example, it may be assumed that the type of the lane is a freeway, and the set inter-vehicle distance read from the inter-vehicle distance table 42 is D2. In this case, the energy-saving travel processor 51c may be configured to read the inter-vehicle distance D2 (for example, 50 m) for the freeway from the inter-vehicle distance table 42. The energy-saving travel processor 51c may be configured to, for example, generate a control signal to be used to move the vehicle 1 (the vehicle 100a) to a target position (the second position A2) corresponding to the set inter-vehicle distance (for example, 50 m) read from the inter-vehicle distance table 42, based on the data acquired by the data obtainer 51a in the traffic situation illustrated in FIG. 8, and output the control signal to the travel processor 52.

The energy-saving travel processor 51c may be configured to, when acquiring the control flag indicating that the energy-saving traveling is to be prioritized, store “4” in the storage 40 as the driving mode set value 43. The energy-saving travel processor 51c may be configured to, when acquiring the control flag indicating that the energy-saving traveling is to be prioritized, perform an automated travel control of the vehicle 1 to cause the vehicle 1 to approach a position facing a gap between two vehicles traveling in parallel, in an extending direction of a lane in which two vehicles travel in parallel, and also perform an automated travel control of the vehicle 1 to allow the inter-vehicle distance to achieve the shortest inter-vehicle distance within an allowable setting range of the inter-vehicle distance table 42. The energy-saving travel processor 51c may be configured to generate a control signal to be used to implement such an automated travel control, based on the data acquired by the data obtainer 51a, and output the control signal to the travel processor 52.

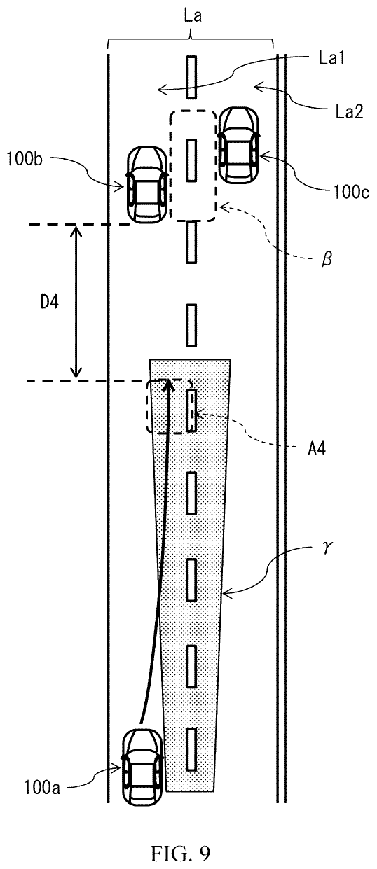

The energy-saving travel processor 51c may further be configured to acquire the type of the lane in which the vehicle 1 (the vehicle 100a) is traveling, based on the data acquired by the data obtainer 51a. The energy-saving travel processor 51c may further be configured to read, from the inter-vehicle distance table 42 in the storage 40, the shortest inter-vehicle distance for the acquired type of the lane within the allowable setting range of the inter-vehicle distance table 42. For example, it may be assumed that the type of the lane is a freeway, and the shortest inter-vehicle distance for the freeway is D4. In this case, the energy-saving travel processor 51c may be configured to read the inter-vehicle distance D4 (for example, 30 m) for the freeway from the inter-vehicle distance table 42. The energy-saving travel processor 51c may be configured to, for example, generate a control signal to be used to move the vehicle 1 (the vehicle 100a) to a target position (the fourth position A4) corresponding to the shortest inter-vehicle distance (for example, 30 m) read from the inter-vehicle distance table 42, based on the data acquired by the data obtainer 51a in the traffic situation illustrated in FIG. 9, and output the control signal to the travel processor 52.

The energy-saving travel processor 51c may be configured to, when acquiring any of the above-described control flags, perform an automated travel control of the vehicle 1 (the vehicle 100a) to prevent the vehicle 1 (the vehicle 100a) from entering the lane La2 adjacent the lane La1 in which the vehicle 1 (the vehicle 100a) is traveling as illustrated in FIGS. 8 and 9, for example. The energy-saving travel processor 51c may be configured to, after the inter-vehicle distance of the vehicle 1 (the vehicle 100a) achieves the set inter-vehicle distance or the shortest inter-vehicle distance in the safe traveling mode or the energy-saving mode, store “2” as the driving mode set value 43 in the storage 40. This may bring the driving mode into the ACC mode, and makes it possible for the energy-saving travel processor 51c to generate a control signal to be used to execute the ACC and output the control signal to the travel processor 52.

### Operation

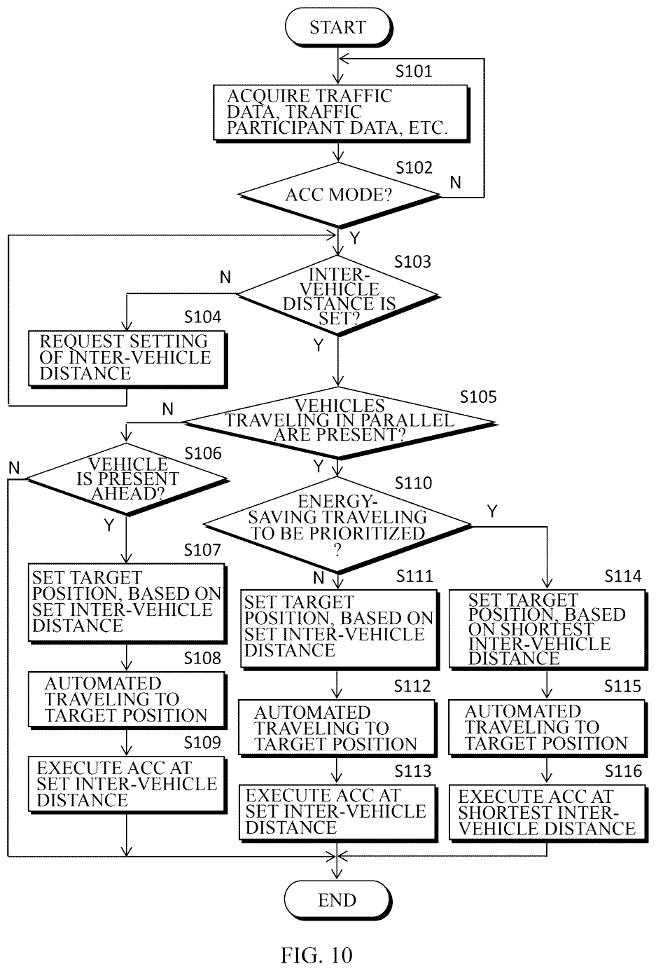

Next, description is given of an operation of the control unit 50 of the vehicle 1 with reference to FIG. 10. FIG. 10 is a flowchart for describing an example of a procedure of controlling traveling of the vehicle 1.

The control unit 50 may acquire, by the data obtainer 51a, various kinds of data from the sensor 10, various kinds of data from the outside of the vehicle 1 via the communicator 20, various kinds of control signals for various kinds of devices of the vehicle 1, and map data around the vehicle 1 from the road map DB 41 in the storage 40. The control unit 50 may acquire, based on the data acquired by the data obtainer 51a, for example but not limited to, the traffic data ahead of the vehicle 1 that is traveling, and the data of the vehicle 1 and the traffic participant data ahead of the vehicle 1 (S101).

The driver who drives the vehicle 1 may, for example, set the driving mode set value 43 by the paddle shift 38, and store the driving mode set value 43 in the storage 40. The driver who drives the vehicle 1 may, for example, set the inter-vehicle distance set value 44 by a touch operation on the center panel display 35, and store the inter-vehicle distance set value 44 in the storage 40.

The control unit 50 may set the driving mode, based on the driving mode set value 43. When the driving mode set value 43 is a value corresponding to the ACC mode (for example, “2”), the control unit 50 may set the driving mode to the ACC mode. When the driving mode is set to the ACC mode (S102: Y), the control unit 50 may determine whether the inter-vehicle distance set value 44 is set in the storage 40 (S103). When the inter-vehicle distance set value 44 is not set in the storage 40 (S103: N), the control unit 50 may request setting of the inter-vehicle distance (S104). The control unit 50 may, for example, output an audio message for setting the inter-vehicle distance, from the speaker 36.

When the inter-vehicle distance set value 44 is set in the storage 40 (S103: Y), the control unit 50 may determine whether two vehicles traveling in parallel are present ahead of the vehicle 1, based on the data acquired by the data obtainer 51a (S105). When two vehicles traveling in parallel are not present ahead of the vehicle 1 (S105: N), the control unit 50 may determine whether one vehicle is present ahead of the vehicle 1, based on the data acquired by the data obtainer 51a (S106). When one vehicle is not present ahead of the vehicle 1 (S106: N), the control unit 50 may end the travel control of the vehicle 1.

When one vehicle is present ahead of the vehicle 1 (S106: Y), the control unit 50 may set the target position, based on the inter-vehicle distance set by the driver, i.e., the set inter-vehicle distance (S107). The target position may be, for example, at a middle position in the width direction of the lane in which the vehicle 1 is traveling unlike the above-described first position A1, the second position A2, etc. The control unit 50 may perform a travel control including, for example but not limited to, an accelerator control, a brake control, and a steering control adapted to move the vehicle 1 from the current position to the target position, based on the data acquired by the data obtainer 51a. As a result, the vehicle 1 may perform automated traveling from the current position to the target position (S108). After the vehicle 1 reaches the target position, the control unit 50 may execute the ACC at the set inter-vehicle distance (S109). As a result, the vehicle 1 may perform automated traveling at the set inter-vehicle distance and at a constant speed.

When it is determined in step S105 that two vehicles traveling in parallel are present ahead of the vehicle 1 (S105: Y), the control unit 50 may make an inquiry of the driver about whether to prioritize the energy-saving traveling. At this time, for example, an audio message inquiring whether to prioritize the energy-saving traveling may be outputted from the speaker 36. When acquiring the response from the driver to the inquiry, the control unit 50 may determine whether the acquired response indicates that the energy-saving traveling is not to be prioritized or that the energy-saving traveling is to be prioritized (S110).

When the acquired response indicates that the energy-saving traveling is not to be prioritized (S110: N), the control unit 50 may set the target position, based on the inter-vehicle distance set by the driver, i.e., the set inter-vehicle distance (S111). The target position may include a target position corresponding to the set inter-vehicle distance read from the inter-vehicle distance table 42. The target position in this case may be, for example but not limited to, the second position A2. The control unit 50 may perform a travel control including, for example but not limited to, an accelerator control, a brake control, and a steering control adapted to move the vehicle 1 from the current position to the target position, based on the data acquired by the data obtainer 51a. As a result, the vehicle 1 may perform automated traveling from the current position to the target position (S112). After the vehicle 1 reaches the target position, the control unit 50 may execute the ACC at the set inter-vehicle distance (S113). As a result, the vehicle 1 may perform automated traveling at the set inter-vehicle distance and at a constant speed.

When the acquired response indicates that the energy-saving traveling is to be prioritized (S110: Y), the control unit 50 may set the target position, based on the shortest inter-vehicle distance acquired from the inter-vehicle distance table 42 (S114). The control unit 50 may perform a travel control including, for example but not limited to, an accelerator control, a brake control, and a steering control adapted to move the vehicle 1 from the current position to the target position, based on the data acquired by the data obtainer 51a. As a result, the vehicle 1 may perform automated traveling from the current position to the target position (S115). After the vehicle 1 reaches the target position, the control unit 50 may execute the ACC at the shortest inter-vehicle distance (S116). As a result, the vehicle 1 may perform automated traveling at the shortest inter-vehicle distance and at a constant speed. In this manner, the travel control of the vehicle 1 may be performed.

### Example Effects

Next, example effects of the vehicle 1 according to the present example embodiment will be described.

In the present example embodiment, when: the ACC is enabled, or when the driving mode is in the ACC mode; and two vehicles traveling in parallel ahead of the vehicle 1 are detected based on the data acquired by the data obtainer 51a, the control unit 50 makes an inquiry of the driver about whether to prioritize the energy-saving traveling. When the response to the inquiry indicates that the energy-saving traveling is not to be prioritized, the automated traveling of the vehicle 1 is controlled to cause the vehicle 1 to approach the position facing the gap between the two vehicles traveling in parallel ahead of the vehicle 1, and the automated traveling of the vehicle 1 is also controlled to achieve the inter-vehicle distance set by the driver, i.e., the set inter-vehicle distance. In contrast, when the response to the inquiry indicates that the energy-saving traveling is to be prioritized, the automated traveling of the vehicle 1 is controlled to cause the vehicle 1 to approach the position facing the gap between the two vehicles traveling in parallel ahead of the vehicle 1, and the automated traveling of the vehicle 1 is also controlled to achieve the shortest inter-vehicle distance acquired from the inter-vehicle distance table 42. Accordingly, it is possible to allow the vehicle 1 to travel with at least part of the vehicle 1 in the low fluid energy region generated by the two vehicles traveling in parallel ahead of the vehicle 1. This helps to improve the fuel consumption or the electric power consumption of the vehicle 1 as compared with a case where the vehicle 1 is caused to travel outside the low fluid energy region.

In some embodiments, the automated traveling of the vehicle 1 may be so controlled that the vehicle 1 does not enter the lane adjacent to the lane in which the vehicle 1 travels. For example, a travel control including, for example but not limited to, an accelerator control, a brake control, and a steering control may be performed that is adapted to move the vehicle 1 to a position where the vehicle 1 does not enter the lane La2 adjacent to the lane La1 in which the vehicle 1 travels. Such a position may include, for example but not limited to, the first position A1, the second position A2, the third position A3, and the fourth position A4. This makes it possible to prevent the vehicle 1 from traveling across the lane line. As a result, for example, it is possible for a vehicle traveling behind the vehicle 1 to overtake the vehicle 1 while traveling in the lane adjacent to the lane in which the vehicle 1 travels. This helps to improve the fuel consumption or the electric power consumption of the vehicle 1 without disturbing the traveling of the vehicle around the vehicle 1. In some embodiments, after the vehicle 1 reaches the target position, the ACC may be executed at the set inter-vehicle distance. Accordingly, it is possible to allow the vehicle 1 to continue traveling with at least part of the vehicle 1 in the low fluid energy region generated by the two vehicles traveling in parallel ahead of the vehicle 1. This helps to improve the fuel consumption or the electric power consumption of the vehicle 1 as compared with a case where the vehicle 1 is caused to continue traveling outside the low fluid energy region.

### 3. Second Example Embodiment

### Configuration Example

FIG. 11 illustrates an example of functional blocks of a vehicle 2 according to a second example embodiment of the disclosure. The vehicle 2 may correspond to an example of the vehicle 100a. As illustrated in FIG. 11, the vehicle 2 may include, for example but not limited to, the sensor 10, the communicator 20, the HMI 30, the storage 40, the control unit 90, the prime mover 60, the brake 70, and the EPS motor 80.

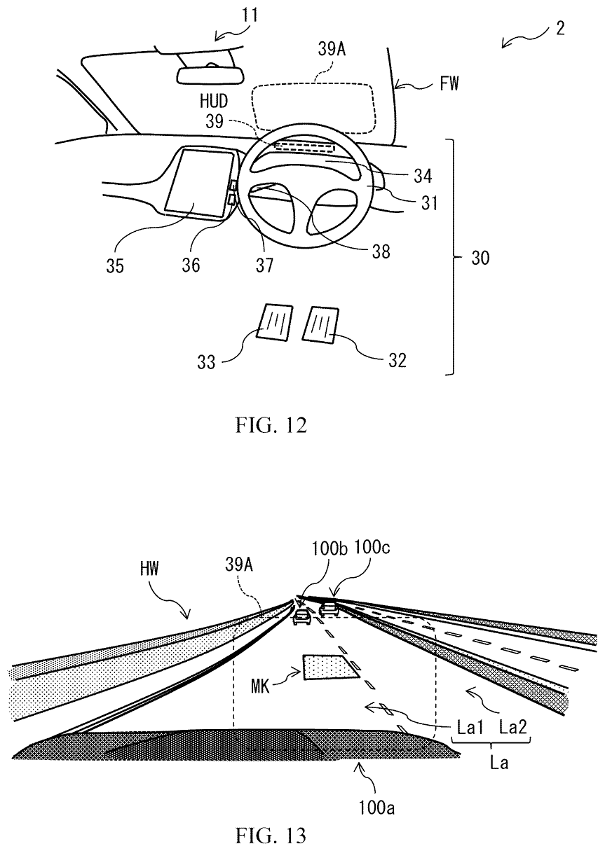

In the present example embodiment, for example, as illustrated in FIG. 12, the HMI 30 may further include a head-up display (HUD) 39. The HUD 39 may include a displaying device configured to project a picture on a display surface 39A of a front windshield FW to superimpose the projected picture on a scene ahead of the vehicle 2. In one embodiment, the HUD 39 may serve as a “display”.

In the present example embodiment, the storage 40 may further hold, for example, a forward position table 45 and a HUD position table 46 as illustrated in FIG. 11.

The forward position table 45 may include position data of the traveling road ahead of the vehicle 2 per pixel in the image data Da or the range image data Db. It may be assumed that the image data Da or the range image data Db includes m×n pixels in which a number of pixels in an X direction is m, and a number of pixels in a Y direction is n. The X direction is a direction corresponding to a width direction of the traveling road ahead of the vehicle 2. The Y direction is a direction corresponding to an extending direction of the traveling road ahead of the vehicle 2. In this case, the forward position table 45 may specify, for example, that the position data of a pixel that corresponds to an m/2-th pixel in the X direction and an n-th pixel in the Y direction in the image data Da or the range image data Db is a position at the middle of the vehicle 2 in the width direction and 20 m ahead of a front end of the vehicle 2. Additionally, the forward position table 45 may specify, for example, that the position data of a pixel that corresponds to an m/2-th pixel in the X direction and a first pixel in the Y direction in the image data Da or the range image data Db is a position at the middle of the vehicle 2 in the width direction and 5 m ahead of the front end of the vehicle 2.

The HUD position table 46 may include position data of the traveling road ahead of the vehicle 2 per pixel on the display surface 39A, or on a picture displayed on the display surface 39A. It may be assumed that the picture displayed on the display surface 39A includes m×n pixels in which a number of pixels in an X direction is m and a number of pixels in a Y direction is n. The X direction, in this case, is a width direction of the display surface 39A. The Y direction, in this case, is a height direction of the display surface 39A. In this case, the HUD position table 46 may specify, for example, that the position data of a pixel that corresponds to an m/2-th pixel in the X direction and an n-th pixel in the Y direction in the picture displayed on the display surface 39A is a position at the middle of the vehicle 2 in the width direction and 10 m ahead of the front end of the vehicle 2. Further, the HUD position table 46 may specify, for example, that the position data of a pixel that corresponds to an m/2-th pixel in the X direction and the first pixel in the Y direction in the picture displayed on the display surface 39A is a position at the middle of the vehicle 2 in the width direction and 3 m ahead of the front end of the vehicle 2.

The control unit 90 may include, for example, a training processor 53 and the travel processor 52 as illustrated in FIG. 11. As illustrated in FIG. 11, the training processor 53 may include, for example but not limited to, a data obtainer 53a, a parallel-traveling vehicle detector 53b, a training proposer 53c, a training evaluator 53d, a HUD drawing processor 53e, and an ACC executor 53f. In one embodiment, the data obtainer 53a may serve as an “obtainer”. In one embodiment, the data obtainer 53a may serve as “circuitry”. In one embodiment, the parallel-traveling vehicle detector 53b, the training proposer 53c, the training evaluator 53d, the HUD drawing processor 53e, and the ACC executor 53f may serve as a “processor”. In one embodiment, the data obtainer 53a, the parallel-traveling vehicle detector 53b, the training proposer 53c, the training evaluator 53d, the HUD drawing processor 53e, and the ACC executor 53f may serve as “circuitry”. In one embodiment, the control unit 90 may serve as a “driving training apparatus”.

The data obtainer 53a may be configured to periodically acquire data regarding a situation or a condition of the vehicle 2. For example, the data obtainer 53a may be configured to periodically acquire, by monitoring, various kinds of data obtained from the sensor 10, various kinds of data obtained from the outside of the vehicle 2 via the communicator 20, and various kinds of control signals for various kinds of devices of the vehicle 2. The data obtainer 53a may further be configured to acquire map data around the vehicle 2 from the road map DB 41 in the storage 40.

The data obtainer 53a may be configured to acquire traffic data ahead of the vehicle 2 that is traveling, based on the acquired data including, for example but not limited to, various kinds of data obtained from the sensor 10, various kinds of data obtained from the outside of the vehicle 2 via the communicator 20, various kinds of data obtained from the HMI 30, various kinds of control signals for various kinds of devices of the vehicle 2, and map data obtained from the road map DB 41. The data obtainer 53a may be configured to acquire data of the vehicle 2 and traffic participant data ahead of the vehicle 2, based on the acquired data including, for example but not limited to, various kinds of data obtained from the sensor 10, various kinds of data obtained from the outside of the vehicle 2 via the communicator 20, various kinds of data obtained from the HMI 30, various kinds of control signals for various kinds of devices of the vehicle 2, and map data obtained from the road map DB 41.

The traffic data ahead of the vehicle 2 included in the data obtained by the data obtainer 53a may include, for example, the above-described road information. In one embodiment, the road information may serve as “traffic data ahead of the vehicle”. The traffic participant data ahead of the vehicle 2 included in the data obtained by the data obtainer 53a may include, for example, the above-described traffic information. In one embodiment, the traffic information may serve as “traffic participant data ahead of the vehicle”.

The parallel-traveling vehicle detector 53b may be configured to detect whether two vehicles traveling ahead of the vehicle 2 are traveling in parallel, based on the data obtained by the data obtainer 53a. The parallel-traveling vehicle detector 53b may be configured to, for example, detect whether the vehicles 100b and 100c are traveling in parallel ahead of the vehicle 2 (the vehicle 100a), based on the data obtained by the data obtainer 53a when the traffic situation ahead of the vehicle 2 (the vehicle 100a) is in the traffic situation as illustrated in FIG. 1.

The training proposer 53c may be configured to, when detecting that two vehicles traveling ahead of the vehicle 2 are traveling in parallel, make an inquiry of the driver about whether to perform dementia prevention training. The training proposer 53c may be configured to, for example, generate an audio signal for the inquiry and output the audio signal to the HMI 30 (the speaker 36). The speaker 36 may be configured to, when the audio signal for the inquiry is received, output audio in accordance with the received audio signal. The speaker 36 may be configured to, for example, output an audio message inquiring whether to perform the dementia prevention training.

The training proposer 53c may be configured to acquire a response from the driver to the inquiry. For example, the microphone 37 may be configured to, after the above-described audio message is outputted from the speaker 36, collect a response in audio from the driver to the above-described audio message. The microphone 37 may be configured to convert the audio from the driver obtained by audio collection into an audio signal and output the audio signal to the control unit 90, or for example, to the training proposer 53c. The training proposer 53c may be configured to acquire a response from the driver to the inquiry by analyzing the audio signal received from the microphone 37.

The training proposer 53c may be configured to analyze whether the response from the driver to the inquiry corresponds to data indicating that the driver agrees to the dementia prevention training or data indicating that the driver does not agree to the dementia prevention training. The training proposer 53c may be configured to, when, as a result of the analysis, the response from the driver to the inquiry corresponds to the data indicating that the driver agrees to the dementia prevention training, output a control flag indicating that the driver agrees to the dementia prevention training to the training evaluator 53d. The training proposer 53c may be configured to, when, as a result of the analysis, the response from the driver to the inquiry corresponds to the data indicating that the driver does not agree to the dementia prevention training, output a control flag indicating that the ACC is to be executed to the ACC executor 53f.

The training evaluator 53d may be configured to, when acquiring the control flag indicating that the driver agrees to the dementia prevention training, cause the storage 40 to store “0” as the driving mode set value 43. The training evaluator 53d may be configured to, when acquiring the control flag indicating that the driver agrees to the dementia prevention training, perform a presentation of the vehicle position when the energy-saving traveling is to be prioritized to the driver. The vehicle position may hereafter be referred to as a “target position”. For example, the target position may include a position facing the gap between the two vehicles traveling in parallel, in the extending direction of the lane in which the two vehicles travel in parallel, and may include a position where the inter-vehicle distance is the shortest within the allowable setting range of the inter-vehicle distance table 42.

The training evaluator 53d may be configured to acquire the type of the lane in which the vehicle 2 is traveling, based on the data acquired by the data obtainer 53a. The training evaluator 53d may further be configured to read, from the inter-vehicle distance table 42 in the storage 40, the shortest inter-vehicle distance for the acquired type of the lane within the allowable setting range of the inter-vehicle distance table 42. For example, it may be assumed that the type of the lane is a freeway, and the shortest inter-vehicle distance for the freeway is D4. The training evaluator 53d may be configured to, in this case, read the inter-vehicle distance D4 (for example, 30 m) for the freeway from the inter-vehicle distance table 42.

The training evaluator 53d may be configured to derive drawing coordinate data of the target position on the HUD 39, or on the picture displayed on the display surface 39A. The training evaluator 53d may be configured to, for example, derive coordinate data of the target position in the image data Da or the range image data Db. The training evaluator 53d may be configured to, for example, derive the coordinate data of the target position on the HUD 39, or on the picture displayed on the display surface 39A, corresponding to the target position in the image data Da or the range image data Db, based on the forward position table 45 and the HUD position table 46. The training evaluator 53d may be configured to, for example, set the coordinate data of the thus-derived target position on the HUD 39, or on the picture displayed on the display surface 39A, as the drawing coordinate data. The training evaluator 53d may be configured to output the obtained drawing coordinate data to the HUD drawing processor 53e.

The HUD drawing processor 53e may be configured to, when receiving the drawing coordinate data from the training evaluator 53d, generate a picture signal that generates a picture including a marker MK at a position corresponding to the drawing coordinate data, and output the picture signal to the HUD 39. The HUD 39 may be configured to, for example, display the picture including the marker MK on the display surface 39A on the front windshield FW as illustrated in FIG. 13, based on the picture signal received from the HUD drawing processor 53e. For example, as illustrated in FIG. 13, the marker MK may be so formed that the target position is filled with a fluorescent color. This makes it possible for the driver who drives the vehicle 2 (the vehicle 100a) to visually recognize the target position while driving the vehicle 2 (the vehicle 100a).

The training evaluator 53d may be configured to, after outputting the drawing coordinate data to the HUD drawing processor 53e, generate a message to notify the driver of the target position, generate an audio signal for the generated message, and output the audio signal to the HMI 30 (the speaker 36). The speaker 36 may be configured to, when the audio signal for the message is received, output audio in accordance with the received audio signal. The speaker 36 may be configured to output, for example, an audio message that notifies the driver of the target position.

The training evaluator 53d may be configured to periodically acquire data obtained by the data obtainer 53a until the vehicle 2 reaches the target position. The training evaluator 53d may be configured to calculate a degree of match between the current position of the vehicle 2 and the target position of the vehicle 2, based on the periodic data acquired from the data obtainer 53a, and make an evaluation of a driving technique of the driver in accordance with the degree of match obtained by the calculation.

The training evaluator 53d may be configured to present a result of the evaluation to the driver. The training evaluator 53d may be configured to, for example, generate an audio signal for the result of the evaluation and output the audio signal to the HMI 30 (the speaker 36). The speaker 36 may be configured to, when the audio signal for the result of the evaluation is received, output audio in accordance with the received audio signal. The speaker 36 may be configured to, for example, output the result of the evaluation as an audio message.

### Operation

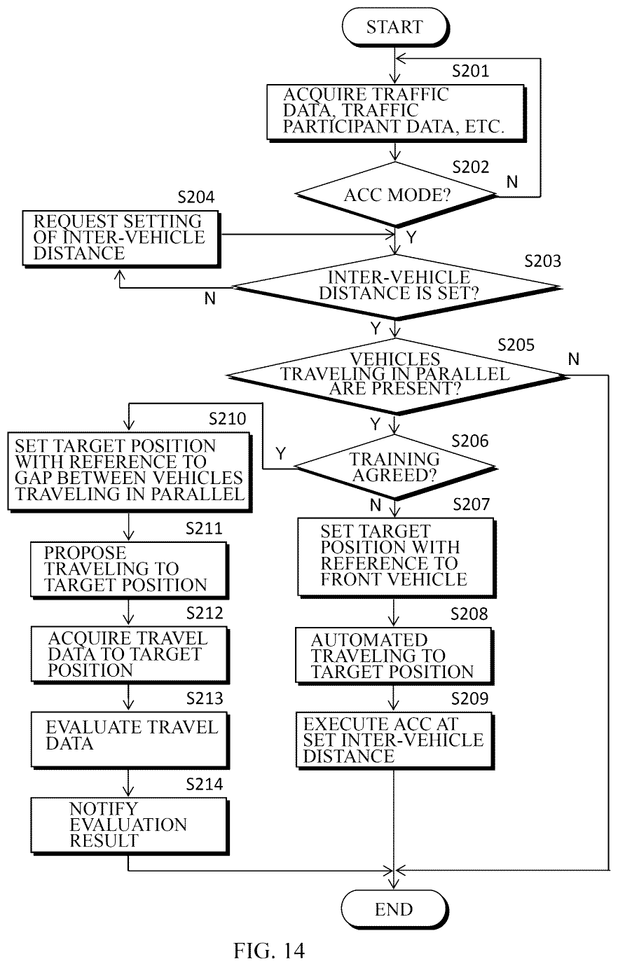

Next, description is given of an operation of the control unit 90 of the vehicle 2 with reference to FIG. 14. FIG. 14 is a flowchart for describing an example of a procedure of controlling traveling and a procedure of evaluating the traveling of the vehicle 2.

The control unit 90 may acquire, by the data obtainer 53a, various kinds of data from the sensor 10, various kinds of data from the outside of the vehicle 2 via the communicator 20, various kinds of control signals for various kinds of devices of the vehicle 2, and map data around the vehicle 2 from the road map DB 41 in the storage 40. The control unit 90 may acquire, based on the acquired data, for example but not limited to, traffic data ahead of the vehicle 2 that is traveling, and the data of the vehicle 2 and the traffic participant data ahead of the vehicle 2 (S201).

The driver who drives the vehicle 2 may, for example, set the driving mode set value 43 by the paddle shift 38, and store the driving mode set value 43 in the storage 40. The driver who drives the vehicle 2 may, for example, set the inter-vehicle distance set value 44 by a touch operation on the center panel display 35, and store the inter-vehicle distance set value 44 in the storage 40.

The control unit 90 may set the driving mode, based on the driving mode set value 43. When the driving mode set value 43 is a value corresponding to the ACC mode (for example, “2”), the control unit 90 may set the driving mode to the ACC mode. When the driving mode is in the ACC mode (S202: Y), the control unit 90 may determine whether the inter-vehicle distance set value 44 is set in the storage 40 (S203). When the inter-vehicle distance set value 44 is not set in the storage 40 (S203: N), the control unit 90 may request setting of the inter-vehicle distance (S204). The control unit 90 may, for example, output an audio message for setting the inter-vehicle distance from the speaker 36.

When the inter-vehicle distance set value 44 is set in the storage 40 (S203: Y), the control unit 90 may determine whether two vehicles traveling in parallel are present ahead of the vehicle 2, based on the data acquired by the data obtainer 53a (S205). When two vehicles traveling in parallel are not present ahead of the vehicle 2 (S205: N), the control unit 90 may write, in the storage 40, a value (for example, “0”) indicating the manual driving mode as the driving mode set value 43, and end the ACC mode.

When two vehicles traveling in parallel are present (S205: Y), the control unit 90 may make an inquiry of the driver about whether to perform the dementia prevention training. At this time, for example, an audio message inquiring whether to perform the dementia prevention training may be outputted from the speaker 36. When obtaining the response from the driver to the inquiry, the control unit 90 may determine whether the obtained response indicates that the driver agrees to perform the dementia prevention training or does not agree to perform the dementia prevention training (S206).

When the acquired response indicates that the driver does not agree to perform the dementia prevention training (S206: N), the control unit 90 may set a target position corresponding to the inter-vehicle distance set by the driver, i.e., the set inter-vehicle distance, with reference to the vehicle traveling ahead of the vehicle 2, i.e., the front vehicle, in the lane in which the vehicle 2 travels (S207). The target position may be, for example, at a middle position in the width direction of the lane in which the vehicle 2 is traveling unlike the above-described first position A1, the second position A2, etc. The control unit 90 may perform a travel control including, for example but not limited to, an accelerator control, a brake control, and a steering control adapted to move the vehicle 2 from the current position to the target position, based on the data acquired by the data obtainer 53a. As a result, the vehicle 2 may perform automated traveling from the current position to the target position (S208). After the vehicle 2 reaches the target position, the control unit 90 may execute the ACC at the set inter-vehicle distance (S209). As a result, the vehicle 2 may perform automated traveling at the set inter-vehicle distance and at a constant speed.

When the acquired response indicates that the driver agrees to perform the dementia prevention training (S206: Y), the control unit 90 may set the target position with reference to the gap between the two vehicles traveling in parallel ahead of the vehicle 2 (S210). The control unit 90 may propose traveling from the current position to the target position to the driver (S211). The control unit 90 may, for example, generate a picture signal that generates a picture including the marker MK at the target position and output the picture signal to the HUD 39. The HUD 39 may, for example, display the picture including the marker MK on the display surface 39A on the front windshield FW as illustrated in FIG. 13, based on the picture signal received from the HUD drawing processor 53e. The control unit 90 may, for example, generate an audio signal for a message that notifies the driver of the target position, and output the audio signal to the speaker 36. The speaker 36 may output an audio message that notifies the driver of the target position, based on the received audio signal. The control unit 90 may periodically acquire the data obtained by the data obtainer 53a until the vehicle 2 reaches the target position (S212). The control unit 90 may calculate the degree of match between the current position of the vehicle 2 and the target position of the vehicle 2, based on the periodic data acquired from the data obtainer 53a, and make an evaluation of the driving technique of the driver in accordance with the degree of match obtained by the calculation (S213). The control unit 90 may present the result of the evaluation to the driver (S214). The control unit 90 may, for example, generate an audio signal for the result of the evaluation and output the audio signal to the speaker 36. The speaker 36 may output the result of the evaluation as an audio message, based on the received audio signal. In this manner, the travel control of the vehicle 2 and travel evaluation may be performed.

### Example Effects

Next, example effects of the vehicle 2 according to the present example embodiment will be described.

In the present example embodiment, when: the ACC is enabled, or when the driving mode is in the ACC mode; and two vehicles traveling in parallel ahead of the vehicle 2 are detected based on the data acquired by the data obtainer 53a, the control unit 90 may make an inquiry of the driver about whether to perform the dementia prevention training. When the response to the inquiry indicates that the driver agrees to the dementia prevention training, the control unit 90 may perform a presentation of a position, or the target position, that faces the gap between the two vehicles traveling in parallel ahead of the vehicle 2 and that achieves the inter-vehicle distance set by the driver, i.e., the set inter-vehicle distance. Thereafter, the control unit 90 may calculate the degree of match between the current position of the vehicle 2 and the target position of the vehicle 2, based on the periodic data acquired from the data obtainer 53a until the driver moves the vehicle 2 to the target position in accordance with such presentation. The control unit 90 may make an evaluation of the driving technique of the driver in accordance with the degree of match obtained by the calculation, and present the result of the evaluation to the driver.

Such an operation of the vehicle by the driver using spatial awareness can serve as the dementia prevention training for the driver. This helps to prevent dementia of the driver. In addition, as a result of such a vehicle operation by the driver using spatial awareness, it is possible to allow the vehicle 2 to travel with at least part of the vehicle 2 in the low fluid energy region generated by the two vehicles traveling in parallel ahead of the vehicle 2. This helps to improve the fuel consumption or the electric power consumption of the vehicle 2 as compared with a case where the vehicle 2 is caused to travel outside the low fluid energy region.

In some embodiments, as the presentation of the target position to the driver, the control unit 90 may generate the picture signal adapted to display the picture including the marker MK at the target position on the HUD 39, and output the picture signal to the HUD 39. As a result, the driver who drives the vehicle 2 may visually recognize the target position while driving the vehicle 2. This makes it possible to allow the driver to use spatial awareness through use of the HUD 39. This helps to prevent dementia of the driver.

### 4. Modification Example of Second Example Embodiment

In the second example embodiment, the ACC mode may be turned off at all times. Even in such a case, it is possible to cause the driver to perform the vehicle operation using spatial awareness. This helps to prevent dementia of the driver. In the second example embodiment, instead of the HUD 39, for example, a picture including the marker MK may be displayed at the target position on the center panel display 35. In this case, because the driver who drives the vehicle 2 is to drive the vehicle 2 while anticipating the target position ahead of the vehicle 2, it is possible to make the driver use spatial awareness. This helps to prevent dementia of the driver.

The “dementia prevention training” may be regarded as an example of driving training. Accordingly, in the second example embodiment, the “dementia prevention training” may be read as the “driving training”. In the second example embodiment, when the “dementia prevention training” is read as the “driving training”, the vehicle operation by the driver using spatial awareness may serve as the driving training for the driver. Furthermore, performing the driving training helps to improve the fuel consumption or the electric power consumption of the vehicle 2.

The disclosure has been described above with reference to some example embodiments; however, the disclosure is not limited to the example embodiments, and various modifications may be made. The example effects described herein are merely examples, and effects of the disclosure are not limited to the effects described herein. Accordingly, any other effect may be achieved by any embodiment of the disclosure.

Furthermore, the disclosure may encompass at least the following embodiments.
(1)

A travel control apparatus to be applied to a vehicle, the travel control apparatus including:
an obtainer configured to acquire traffic data ahead of the vehicle and traffic participant data ahead of the vehicle; and
a travel processor configured to execute an adaptive cruise control, based on the traffic data and the traffic participant data that are acquired by the obtainer, in which
the travel processor is
configured to, when: the adaptive cruise control is enabled; and a first front vehicle and a second front vehicle are detected to be traveling in parallel ahead of the vehicle, based on the traffic data and the traffic participant data, make an inquiry of a driver who drives the vehicle about whether to prioritize energy-saving traveling,
configured to, when the obtainer acquires first data indicating that the energy-saving traveling is not to be prioritized as a response to the inquiry, perform an automated travel control of the vehicle and cause the vehicle to approach a position facing a gap between the first front vehicle and the second front vehicle, and perform an automated travel control and achieve an inter-vehicle distance set by the driver, and
configured to, when the obtainer acquires second data indicating that the energy-saving traveling is to be prioritized as a response to the inquiry, perform an automated travel control of the vehicle and cause the vehicle to approach the position facing the gap between the first front vehicle and the second front vehicle, and perform an automated travel control and achieve a shortest inter-vehicle distance in an allowable setting range.
(2)

The travel control apparatus according to (1), in which the travel processor is configured to, when the obtainer acquires the first data or the second data, perform an automated travel control of the vehicle and prevent the vehicle from entering a lane adjacent to a traveling lane in which the vehicle is traveling.
(3)

The travel control apparatus according to (1) or (2), in which the travel processor is configured to, after an inter-vehicle distance has reached the inter-vehicle distance set by the driver, execute the adaptive cruise control.
(4)

A driving training apparatus to be applied to a vehicle, the driving training apparatus including:
an obtainer configured to acquire traffic data ahead of the vehicle and traffic participant data ahead of the vehicle; and
a processor configured to execute driving training, based on the traffic data and the traffic participant data that are acquired by the obtainer, in which
the processor is
configured to, when a first front vehicle and a second front vehicle are detected to be traveling in parallel ahead of the vehicle, based on the traffic data and the traffic participant data, make an inquiry of a driver who drives the vehicle about whether to perform the driving training, and
configured to, when the obtainer acquires data indicating that the driver agrees to the driving training as a response to the inquiry, perform a presentation of a vehicle position when the energy-saving traveling is to be prioritized to the driver, make an evaluation in accordance with a degree of match between the position of the vehicle and the presented vehicle position, and present a result of the evaluation to the driver.
(5)

The driving training apparatus according to (4), in which the processor is configured to, as the presentation of the vehicle position to the driver, generate a signal adapted to cause a display to display a picture including the vehicle position, and output the signal to the display.
(6)

A vehicle including
a travel control apparatus, in which
the travel control apparatus includes:
   an obtainer configured to acquire traffic data ahead of the vehicle and traffic participant data ahead of the vehicle; and
   a travel processor configured to execute an adaptive cruise control, based on the traffic data and the traffic participant data that are acquired by the obtainer,
the travel processor is
configured to, when: the adaptive cruise control is enabled; and a first front vehicle and a second front vehicle are detected to be traveling in parallel ahead of the vehicle, based on the traffic data and the traffic participant data, make an inquiry of a driver who drives the vehicle about whether to prioritize energy-saving traveling,
configured to, when the obtainer acquires first data indicating that the energy-saving traveling is not to be prioritized as a response to the inquiry, perform an automated travel control of the vehicle and cause the vehicle to approach a position facing a gap between the first front vehicle and the second front vehicle, and perform an automated travel control and achieve an inter-vehicle distance set by the driver, and
configured to, when the obtainer acquires second data indicating that the energy-saving traveling is to be prioritized as a response to the inquiry, perform an automated travel control of the vehicle and cause the vehicle to approach the position facing the gap between the first front vehicle and the second front vehicle, and perform an automated travel control and achieve a shortest inter-vehicle distance in an allowable setting range.
(7)

A vehicle including
a driving training apparatus, in which
the driving training apparatus includes:
   an obtainer configured to acquire traffic data ahead of the vehicle and traffic participant data ahead of the vehicle; and
   a processor configured to execute driving training, based on the traffic data and the traffic participant data that are acquired by the obtainer,
the processor is
configured to, when a first front vehicle and a second front vehicle are detected to be traveling in parallel ahead of the vehicle, based on the traffic data and the traffic participant data, make an inquiry of a driver who drives the vehicle about whether to perform the driving training, and
configured to, when the obtainer acquires data indicating that the driver agrees to the driving training as a response to the inquiry, perform a presentation of a vehicle position when the energy-saving traveling is to be prioritized to the driver, make an evaluation in accordance with a degree of match between the position of the vehicle and the presented vehicle position, and present a result of the evaluation to the driver.
(8)

A travel control apparatus to be applied to a vehicle, the travel control apparatus including circuitry configured to execute an adaptive cruise control, in which
the circuitry is
configured to acquire traffic data ahead of the vehicle and traffic participant data ahead of the vehicle,
configured to, when: the adaptive cruise control is enabled; and a first front vehicle and a second front vehicle are detected to be traveling in parallel ahead of the vehicle, based on the traffic data and the traffic participant data that have been acquired, make an inquiry of a driver who drives the vehicle about whether to prioritize energy-saving traveling,
configured to, when first data indicating that the energy-saving traveling is not to be prioritized is acquired as a response to the inquiry, perform an automated travel control of the vehicle and cause the vehicle to approach a position facing a gap between the first front vehicle and the second front vehicle, and perform an automated travel control and achieve an inter-vehicle distance set by the driver, and
configured to, when second data indicating that the energy-saving traveling is to be prioritized is acquired as a response to the inquiry, perform an automated travel control of the vehicle and cause the vehicle to approach the position facing the gap between the first front vehicle and the second front vehicle, and perform an automated travel control and achieve a shortest inter-vehicle distance in an allowable setting range.
(9)

A driving training apparatus to be applied to a vehicle, the driving training apparatus including
circuitry configured to execute driving training, in which
the circuitry is
configured to acquire traffic data ahead of the vehicle and traffic participant data ahead of the vehicle,
configured to, when a first front vehicle and a second front vehicle are detected to be traveling in parallel ahead of the vehicle, based on the traffic data and the traffic participant data that have been acquired, make an inquiry of a driver who drives the vehicle about whether to perform the driving training, and
configured to, when data indicating that the driver agrees to the driving training is acquired as a response to the inquiry, perform a presentation of a vehicle position when the energy-saving traveling is to be prioritized to the driver, make an evaluation in accordance with a degree of match between the position of the vehicle and the presented vehicle position, and present a result of the evaluation to the driver.
(10)

A vehicle including
circuitry configured to execute an adaptive cruise control, in which
the circuitry is
configured to acquire traffic data ahead of the vehicle and traffic participant data ahead of the vehicle,
configured to, when: the adaptive cruise control is enabled; and a first front vehicle and a second front vehicle are detected to be traveling in parallel ahead of the vehicle, based on the traffic data and the traffic participant data that have been acquired, make an inquiry of a driver who drives the vehicle about whether to prioritize energy-saving traveling,
configured to, when first data indicating that the energy-saving traveling is not to be prioritized is acquired as a response to the inquiry, perform an automated travel control of the vehicle and cause the vehicle to approach a position facing a gap between the first front vehicle and the second front vehicle, and perform an automated travel control and achieve an inter-vehicle distance set by the driver, and
configured to, when second data indicating that the energy-saving traveling is to be prioritized is acquired as a response to the inquiry, perform an automated travel control of the vehicle and cause the vehicle to approach the position facing the gap between the first front vehicle and the second front vehicle, and perform an automated travel control and achieve a shortest inter-vehicle distance in an allowable setting range.

Although the disclosure has been described hereinabove in terms of the example embodiment and modification examples, the disclosure is not limited thereto. It should be appreciated that variations may be made in the described example embodiment and modification examples by those skilled in the art without departing from the scope of the disclosure as defined by the following claims. The disclosure is intended to include such modifications and alterations in so far as they fall within the scope of the appended claims or the equivalents thereof.

The limitations in the claims are to be interpreted broadly based on the language employed in the claims and not limited to examples described in this specification or during the prosecution of the application, and the examples are to be construed as non-exclusive.

As used in this specification and the appended claims, the singular forms “a,” “an,” and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated element, integer, or step but not the exclusion of any other non-stated element, integer, or step.

The use of the terms first, second, etc. do not denote any order or importance, but rather the terms first, second, etc. are used to distinguish one element from another.

The term “substantially”, “approximately”, “about”, and its variants having the similar meaning thereto are defined as being largely but not necessarily wholly what is specified as understood by one of ordinary skill in the art.

The term “disposed on/provided on/formed on” and its variants having the similar meaning thereto as used herein refer to elements disposed directly in contact with each other or indirectly by having intervening structures therebetween.

The control unit 50 illustrated in FIG. 3 and the control unit 90 illustrated in FIG. 11 are implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the control unit 50 illustrated in FIG. 3 and the control unit 90 illustrated in FIG. 11. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the control unit 50 illustrated in FIG. 3 and the control unit 90 illustrated in FIG. 11.

1. A travel control apparatus configured to be applied to a vehicle, the travel control apparatus comprising a processor configured to
acquire traffic data ahead of the vehicle and traffic participant data ahead of the vehicle, and
execute an adaptive cruise control, based on the traffic data and the traffic participant data, wherein
the processor is configured to
when: the adaptive cruise control is enabled; and a first front vehicle and a second front vehicle are detected to be traveling in parallel ahead of the vehicle, based on the traffic data and the traffic participant data, make an inquiry of a driver who drives the vehicle about whether to prioritize energy-saving traveling,
upon acquiring first data indicating that the energy-saving traveling is not to be prioritized as a response to the inquiry, perform an automated travel control of the vehicle and cause the vehicle to approach a position facing a gap between the first front vehicle and the second front vehicle, and perform an automated travel control and achieve an inter-vehicle distance set by the driver, and
upon acquiring second data indicating that the energy-saving traveling is to be prioritized as a response to the inquiry, perform an automated travel control of the vehicle and cause the vehicle to approach the position facing the gap between the first front vehicle and the second front vehicle, and perform an automated travel control and achieve a shortest inter-vehicle distance in an allowable setting range.

2. The travel control apparatus according to claim 1, wherein the processor is configured to, upon acquiring the first data or the second data, perform an automated travel control of the vehicle and prevent the vehicle from entering a lane adjacent to a traveling lane in which the vehicle is traveling.

3. A driving training apparatus configured to be applied to a vehicle, the driving training apparatus a processor configured to
acquire traffic data ahead of the vehicle and traffic participant data ahead of the vehicle, and
execute driving training, based on the traffic data and the traffic participant data, wherein
the processor is configured to
when a first front vehicle and a second front vehicle are detected to be traveling in parallel ahead of the vehicle, based on the traffic data and the traffic participant data, make an inquiry of a driver who drives the vehicle about whether to perform the driving training, and
upon acquiring data indicating that the driver agrees to the driving training as a response to the inquiry, perform a presentation of a vehicle position when the energy-saving traveling is to be prioritized to the driver, make an evaluation in accordance with a degree of match between the position of the vehicle and the presented vehicle position, and present a result of the evaluation to the driver.

4. The driving training apparatus according to claim 3, wherein the processor is configured to, as the presentation of the vehicle position to the driver, generate a signal adapted to cause a display to display a picture including the vehicle position, and output the signal to the display.

5. A vehicle comprising
a travel control apparatus comprising a processor configured to
acquire traffic data ahead of the vehicle and traffic participant data ahead of the vehicle, and
execute an adaptive cruise control, based on the traffic data and the traffic participant data, wherein
the processor is configured to
when: the adaptive cruise control is enabled; and a first front vehicle and a second front vehicle are detected to be traveling in parallel ahead of the vehicle, based on the traffic data and the traffic participant data, make an inquiry of a driver who drives the vehicle about whether to prioritize energy-saving traveling,
upon acquiring first data indicating that the energy-saving traveling is not to be prioritized as a response to the inquiry, perform an automated travel control of the vehicle and cause the vehicle to approach a position facing a gap between the first front vehicle and the second front vehicle, and perform an automated travel control and achieve an inter-vehicle distance set by the driver, and
upon acquiring second data indicating that the energy-saving traveling is to be prioritized as a response to the inquiry, perform an automated travel control of the vehicle and cause the vehicle to approach the position facing the gap between the first front vehicle and the second front vehicle, and perform an automated travel control and achieve a shortest inter-vehicle distance in an allowable setting range.
